(19) United States
(12) Patent Application Publication
(10) Pub. No.: US 2018/0324703 A1
(43) Pub. Date: Nov. 8, 2018

(54) SYSTEMS AND METHODS TO PLACE DIGITAL ASSISTANT IN SLEEP MODE FOR PERIOD OF TIME

(71) Applicant: Lenovo (Singapore) Pte. Ltd., New Tech Park (SG)

(72) Inventors: Ryan Charles Knudson, Durham, NC (US); Timothy Winthrop Kingsbury, Cary, NC (US); Christopher Donald Oman, Fort Wayne, IN (US); Matthew Jacyno, Fort Wayne, IN (US)

(21) Appl. No.: 15/584,315

(22) Filed: May 2, 2017

(51) Int. Cl. H04W 52/02; G06F 9/44

(52) U.S. Cl. CPC H04W 52/0258; H04W 76/048; G06F 9/4446

(57) ABSTRACT

In one aspect, a device includes at least one processor and storage accessible to the at least one processor. The storage bears instructions executable by the at least one processor to operate a digital assistant, receive input indicating that the digital assistant should be placed in a sleep mode, and place the digital assistant in the sleep mode for a period of time responsive to receipt of the input.

### BACKGROUND

As recognized herein, many current digital assistants constantly listen for a wake up word that cues the digital assistant that a user command is about to be provided for which the digital assistant is to take an action. This can be frustrating at times to a user, such as when the wake up word is spoken in conversation not meant to cue the digital assistant or when the wake up word is provided in audio of a television advertisement that the user does not wish to cue the digital assistant. Other times the user may simply wish that the digital assistant not listen and respond to user commands based on the speaking of the wake up word. There are currently no adequate solutions to the foregoing computer-related, technological problem.

### SUMMARY

Accordingly, in one aspect a device includes at least one processor and storage accessible to the at least one processor. The storage bears instructions executable by the at least one processor to operate a digital assistant, receive input indicating that the digital assistant should be placed in a sleep mode, and place the digital assistant in the sleep mode for a period of time responsive to receipt of the input.

In another aspect, a method includes operating, at a device, a personal assistant in a first mode and receiving, at the device, input to place the personal assistant in a second mode different from the first mode. In the second mode, the personal assistant does not process speech other than of a phrase to transition the personal assistant back to the first mode. The method also includes operating the personal assistant in the second mode for a period of time responsive to receiving the input, and then operating the personal assistant in the first mode responsive to a determination pertaining to the period of time.

In still another aspect, an apparatus includes a first processor, a network adapter, and storage. The storage bears instructions executable by at least one second processor of a device for operating, at the device, a personal assistant in a first mode and receiving, at the device, first input indicative of a circumstance for which to operate the personal assistant in a second mode different from the first mode. In the second mode, the personal assistant does not respond to a primary wake up phrase for the personal assistant and does not respond to user requests for information. The instructions are also executable for operating, at the device and responsive to receiving the first input, the personal assistant in the second mode for a period of time. Still further, the instructions are executable for receiving, at the device, second input indicative of a circumstance for which to operate the personal assistant in the first mode and operating, at the device and responsive to receiving the second input, the personal assistant in the first mode. The first processor transfers the instructions to the device over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIGS. 3 and 4 are example illustrations in accordance with present principles;

FIG. 5 is a flow chart of an example algorithm in accordance with present principles;

FIGS. 6 and 8 are example user interfaces (UIs) in accordance with present principles; and

FIG. 7 shows an example digital/personal assistant device in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

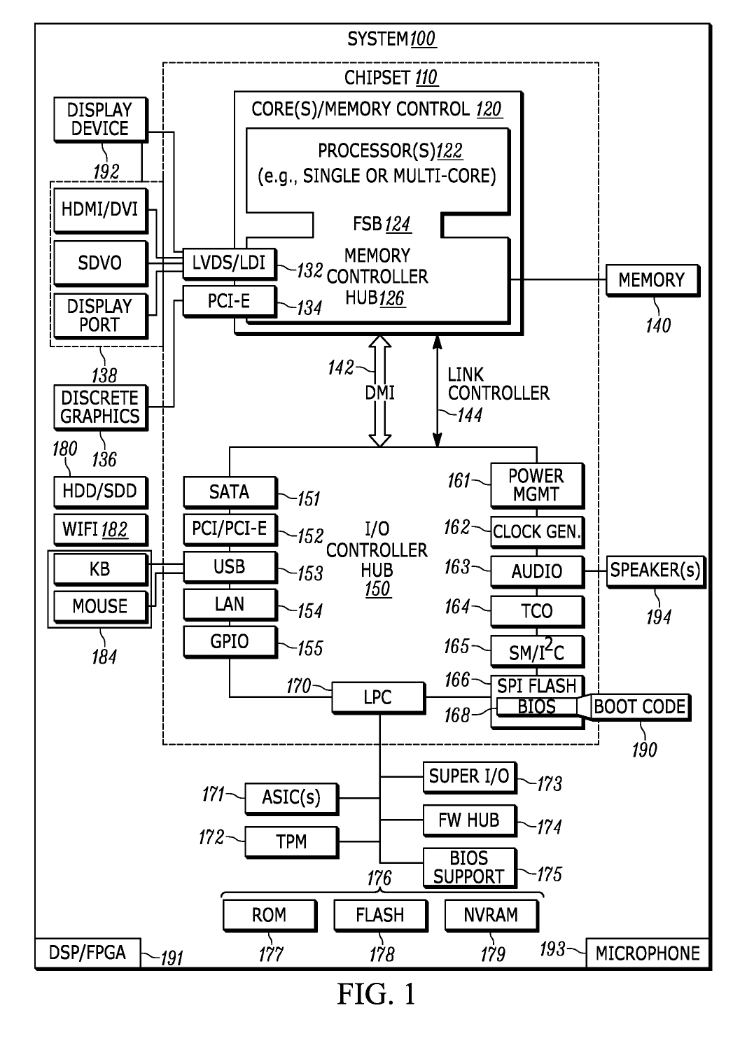

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, in some embodiments the system 100 may include a digital signal processor (DSP) and/or field programmable gate array (FPGA) 191 that communicates with the processor(s) 122 (such as general-purpose processors). In addition to communicating with each other, both of the DSP/FPGA 191 and the processor(s) 122 may receive input from an audio receiver/microphone 193 that provides the input based on audio that is detected at the microphone 193, such as via a user providing audible input to the microphone 193.

Additionally, though not shown for clarity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. The system may also include a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

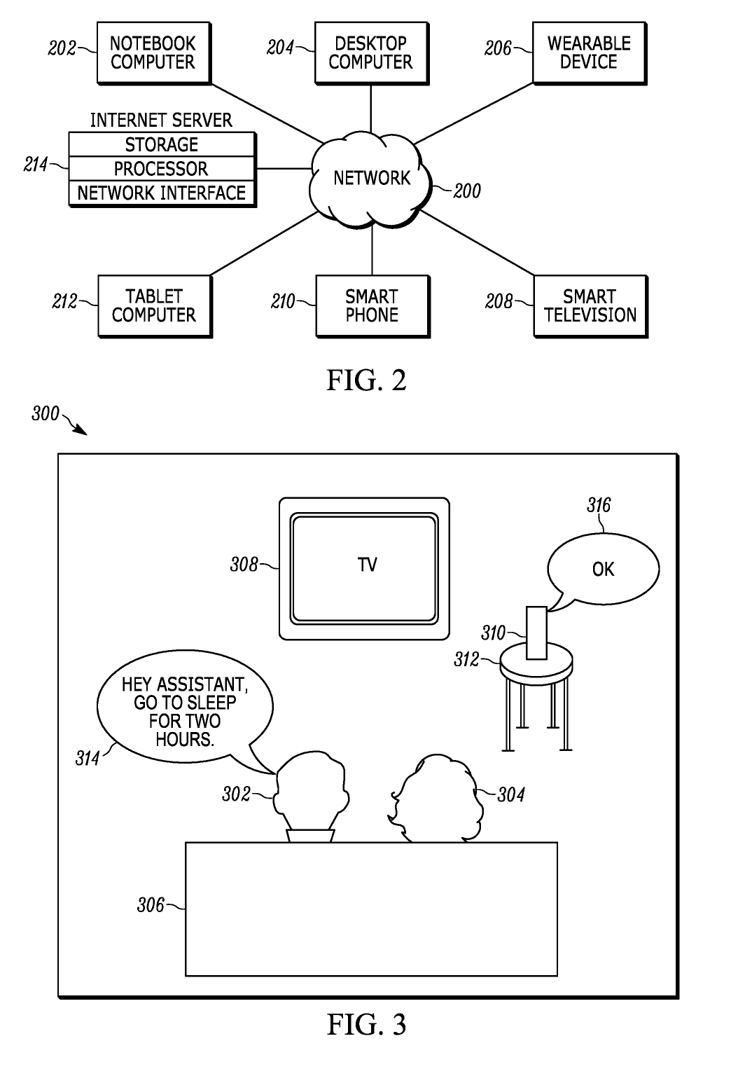

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles, such as searching for information complying with a user request.

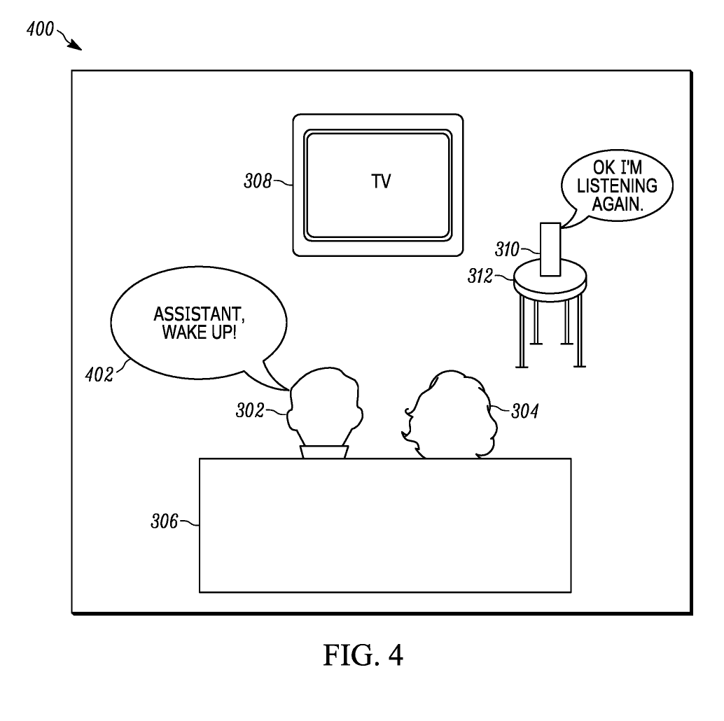

Now referring to FIG. 3, it shows an example illustration 300 in accordance with present principles. A first user 302 and a second user 304 are depicted as sitting on a couch 306 while watching audio video content presented on a television 308. A stand-alone device 310 operating a digital/personal assistant is also shown as sitting on a table 312. The assistant may execute functions in conformance with user requests (such as placing a telephone call or sending an email), may search for information based on a user request for information, etc. Thus, the functions the assistant is able to execute may be generally similar to those executed by Amazon's Alexa or Apple's Siri, for instance.

As may be appreciated from FIG. 3, the first user 302 issues an audible command 314 that may include a predefined sleep phrase (e.g., “hey assistant, go to sleep”) and instruct the assistant to go to sleep for a predefined, quantifiable amount of time (in this case, “for two hours”). However, it is to be understood that other predefined periods of time may be specified, such as one that is not quantified in terms of units of time such as seconds, minutes, hours, etc. but instead one that is defined by the duration of an event or occurrence. For example, the predefined period of time may be for while a particular conversation between the first user 302 and second user 304 takes place, while a meeting noted in an electronic calendar accessible to the device 310 takes place, while the users 302, 304 watch television for however long they choose, etc.

In any case, in response to the audible command 314 from the first user 302, the assistant operating at the device 310 may provide an audible response 316 such as “ok” and place itself in a sleep mode in which the assistant does not process/recognize input of user requests (or input of a primary wake up phrase) while in the sleep mode, except that in some cases audible input of a secondary wake up phrase/wake-from-sleep phrase may be received and processed to transition the assistant from the sleep mode back to an active mode. In other embodiments, no audible input may be processed while in the sleep mode, including any secondary wake up phrase. But in either case, should the primary wake up phrase or an apparent user request be spoken while the assistant is in the sleep mode, the assistant will still not recognize as much and will instead take no action to thus prevent inadvertent input to the assistant.

Then, as may be appreciated from the illustration 400 shown in FIG. 4, the user 302 may provide an audible command 402 at a later time that instructs the assistant to transition from the sleep mode to the active mode, and in response the audible assistant may transition to the active mode and provide an audible response that it is complying with the command 402. In this example, the secondary wake up phrase is “assistant wake up” and the audible response is “ok I'm listening again”.

Based on the foregoing, it is to be more generally understood that a secondary wake up phrase in accordance with present principles may be different from a primary wake up phrase that is usable while the assistant is not in its sleep mode. The primary wake up phrase may be spoken while the device is in its active mode in order to provide an indicator or trigger that a user request is about to be provided to the assistant for the assistant to execute a function or perform a task in conformance with the user request.

Furthermore, it is to be understood that in some embodiments the assistant may be implemented using both a general purpose processor/central processing unit (CPU) and also a dedicated processor such as a digital signal processor (DSP) or field programmable gate array (FPGA). In such an embodiment, the general purpose processor/CPU may operate the assistant while in the active mode, while the DSP or FPGA may operate at least one facet of the assistant in the sleep mode such as recognition of audible input of the secondary wake up phrase even if the DSP/FPGA does not operate other facets of the assistant such as the device might otherwise do while the assistant is in the active mode.

However, it is to be further understood that in other embodiments, the general purpose processor/CPU of the device 310 may operate the assistant in both the active and sleep modes without the aid of a DSP or FPGA. But regardless of whether a DSP or FPGA is used to implement the assistant, in non-limiting embodiments the assistant while in the sleep mode may not store data pertaining to audible input that would otherwise be received at the device 310 during that time if not in the sleep mode (as it might otherwise do in the active mode such as to identify context for a possible future user request), save for data pertaining to the secondary wake up phrase that might be received while in the sleep mode. Instead, the audible input other than the secondary wake up phrase that is received while the assistant is in the sleep mode may simply be ignored or disregarded.

Additionally, in non-limiting embodiments, while in the sleep mode the assistant may not be used to access data stored prior to entering the sleep mode, perform an Internet search, or otherwise comply with a user request, except for data that might be accessed to recognize the secondary wake up phrase to then transition the assistant to the active mode.

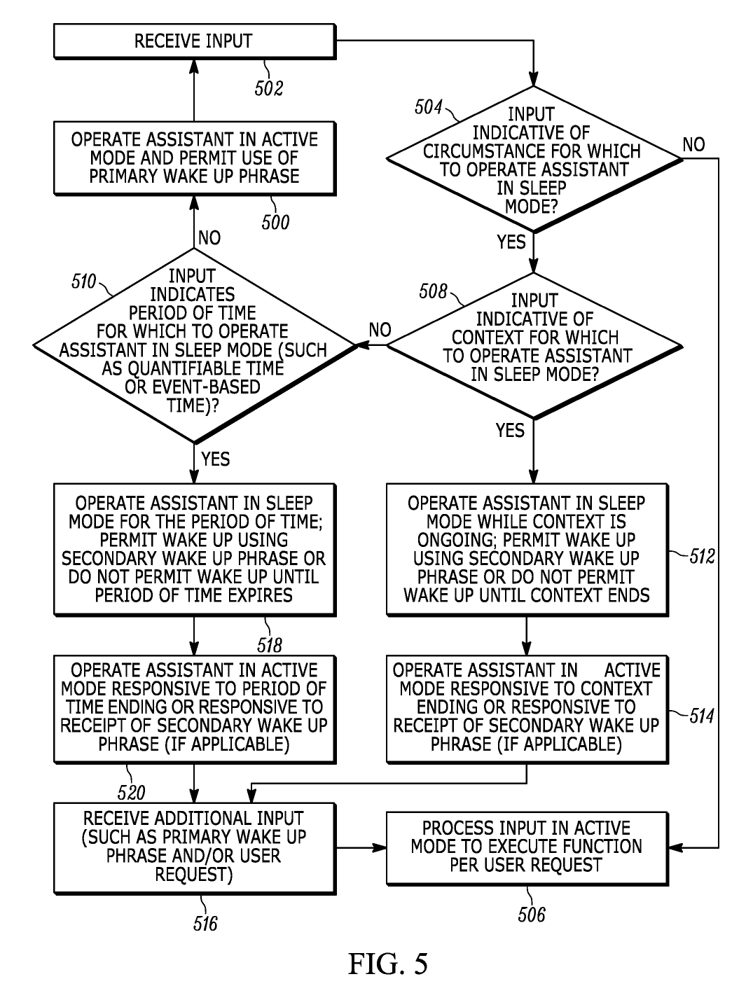

Continuing the detailed description in reference to FIG. 5, it shows example logic that may be executed by a device such as the system 100 and/or device 310 in accordance with present principles. Beginning at block 500, the device may operate a digital/personal assistant in an active mode and permit use of a primary wake up phrase to cue or trigger the assistant that a user request is about to be provided. This may be done by executing voice recognition software using the assistant to process input from a microphone on the device that senses a user's voice. From block 500 the logic may proceed to block 502 where the logic may actually receive audible input (or even another type of input, such as touch input directed to a touch-enabled display of the device or input to a physical button or switch on the device).

From block 502 the logic may then proceed to decision diamond 504. At diamond 504 the logic may determine whether the input is indicative of a circumstance for which to operate the assistant in a sleep mode rather than the active mode. The circumstance may be a user providing a predefined sleep phrase (e.g., one or more words) that instructs the assistant to be placed in the sleep mode for a quantifiable period of time indicated with the sleep phrase, or a user providing the sleep phrase and instructing the assistant to be placed in a sleep mode for the duration of a given context provided with the sleep phrase, such as while a meeting is ongoing or while the user converses with another person. Examples of sleep phrases include “assistant, buzz off”, “stop listening, assistant” and “go to sleep, assistant”.

The circumstance may also be inferred from the input without a user command to be placed in the sleep mode being received, such as the logic inferring that a conversation between two people is ongoing based on input from a microphone on the device and placing the assistant in the sleep mode for the duration of the conversation, after which the logic may recognize the lack of sound and in response place the assistant back in the active mode.

Should it be determined at diamond 504 that the input received at block 502 was not indicative of such a circumstance, the logic may move to block 506. For example, a negative determination at diamond 504 may result if the input received at block 502 was input of the primary wake up phrase and a corresponding user request. Thus, at block 506 the logic, while still in the active mode, may process the input to execute a function per a user request contained in the input.

However, should an affirmative determination be made at diamond 504 instead, the logic may instead proceed from decision diamond 504 to decision diamond 508. At diamond 508 the logic may determine whether the input received at block 502 is indicative a context for which to transition the assistant to the sleep mode. As indicated above, this context may be identified based on input from a sensor such as a microphone or even camera in communication with the device, but without receiving an actual user command via audible input to place the assistant in sleep mode (e.g., without receiving the sleep phrase). Using the conversation example from above, a conversation context may be identified based on camera input which may be analyzed using object and/or gesture recognition software to determine that two people are engaged in a conversation, and/or based on microphone input which may be analyzed using voice recognition software to determine that two people are engaged in a conversation.

The context to place the assistant in the sleep mode may also be identified based on data in an electronic calendar accessible to the device, again without receiving an actual user command via audible input to place the assistant in the sleep mode. For instance, anytime an appointment is indicated in the electronic calendar, the assistant may be placed in the sleep mode for the duration of the appointment as indicated in the calendar.

A negative determination at diamond 508 may cause the logic to move to decision diamond 510, which will be described shortly. However, first note that an affirmative determination at diamond 508 may cause the logic to move to block 512 instead. At block 512 responsive to the affirmative determination at diamond 508, the logic may transition the assistant to the sleep mode. In some examples at block 512, while the assistant is in the sleep mode the logic may still permit the assistant to wake up to transition back to the active mode based on identification of the secondary wake up phrase as might be received from the user while in the sleep mode, even if received while the identified context is still ongoing. However, in other examples, at block 512 while the assistant is in the sleep mode the assistant may not be awoken to transition back to the active mode based on identification of any wake up phrase, secondary or otherwise, but instead may remain in the sleep mode until the logic identifies that the context has ended or no longer exists.

From block 512 the logic may move to block 514. At block 514 the logic may transition the assistant to the active mode responsive to the identified context ending, and/or responsive to receipt of the secondary wake up phrase should the secondary wake up phrase feature be enabled. As an example of the assistant being transitioned to the active mode responsive to the identified context ending, when the conversation between the user and other person referenced above has been identified as ending or no longer continuing (e.g., based on camera and/or microphone input), the logic may transition the assistant back to the active mode. As another example of the assistant being transitioned to the active mode responsive to the identified context ending, the assistant may be transitioned to the active mode responsive to the appointment referenced above concluding at a time indicated in the electronic calendar. From block 514 the logic may then proceed to block 516, which will be described shortly.

But first, reference is made to diamond 510. At diamond 510 the logic may determine whether the input received at block 502 indicates one or both of the predefined sleep phrase and a period of time for which to place the assistant in the sleep mode. The input may indicate a quantifiable amount of time such as two hours or an amount of time defined in some other way such as conclusion of a certain event such as a television show or conversation, or conclusion of an action such as the user driving a motor vehicle (as may be identified based on Bluetooth communication between the device and vehicle to determine whether the vehicle is on or off, for example).

A negative determination at diamond 510 may in some examples result in a timeout or indeterminate input conclusion by the device, which may result in the assistant audibly asking for further clarification from the user as to the user's instruction. Additionally or alternatively, a negative determination at diamond 510 may simply cause the logic to revert back to block 500 so that the logic may again proceed therefrom.

However, responsive to an affirmative determination at diamond 510, the logic may instead move to block 518. At block 518 the logic may transition the assistant to the sleep mode for the user-indicated period of time. In some examples at block 518, while the assistant is in the sleep mode the logic may still permit the assistant to wake up to transition back to the active mode based on identification of the secondary wake up phrase as might be received from the user while in the sleep mode, even if received prior to expiration of the period of time. However, in other examples, at block 518 while the assistant is in the sleep mode the assistant may not be awoken to transition back to the active mode based on identification of any wake up phrase, secondary or otherwise, but instead may remain in the sleep mode until expiration of the period of time.

From block 518 the logic may move to block 520. At block 520 the logic may transition the assistant to the active mode responsive to the period of time lapsing or expiring, and/or responsive to receipt of the secondary wake up phrase should the secondary wake up phrase feature be enabled. The period of time may be tracked using input from an electronic timer and/or clock software executing at the device if the period of time is quantifiable. If the period of time is not a quantifiable amount of time but instead, e.g., event-dependent, the period of time may be tracked using input from a sensor or electronic calendar to determine when the period of time has concluded.

For example, if the period of time is defined as the duration of a conversation, input from a microphone and/or camera may be used to determine that no input indicative of audible conversing has been received for a threshold period of time, and responsive to that threshold period of time concluding the logic may transition the assistant back to the active mode. As another example, if the period of time is defined as the duration of an appointment, data from the calendar indicating the appointment end time may be identified and then input from a clock application executing at the device may be used to track time and identify when the end time has been reached, responsive to which the assistant may be transitioned back to the active mode.

From block 520 the logic may then proceed to block 516. At block 516 the logic may receive additional input from the user, such as input of the primary wake up phrase and/or input of a user request such as a request for information, a request to send a text message, etc. It is to be understood that in some embodiments, receipt of the secondary wake up phrase and the ensuing transition back to the active mode may itself cue or trigger the assistant to listen for a user request that is about to be provided without also receiving the primary wake up phrase from the user. However, in other embodiments receipt of the secondary wake up phrase and the ensuing transition back to the active mode may simply cue or trigger the assistant to listen for the primary wake up phrase and not perform a function based on a user request unless the primary wake up phrase is received prior to the user request.

From block 516 the logic may then continue to block 506. At block 506 the logic while in the active mode may process a user request received at block 516 to execute a function per the user request in accordance with present principles.

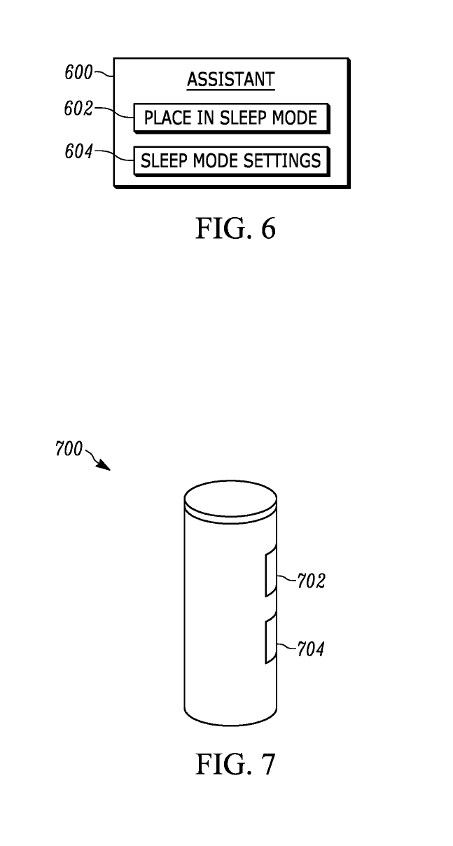

Now in reference to FIG. 6, an example user interface 600 is shown. The UI 600 may be presented on a display accessible to a digital/personal assistant in accordance with present principles, and/or a display of a device that otherwise controls the assistant in accordance with present principles. For example, the UI 600 may be presented on the display of a smart phone that either executes the assistant at the smart phone itself or communicates with another device (e.g., stand-alone device) executing the assistant.

In any case, the UI 600 may include a first selector 602. The selector 602 may be selectable to automatically without further user input provide a command for the assistant to be transitioned to a sleep mode as described herein. Thus, responsive to receipt of input directed to the selector 602, the assistant may be transitioned to the sleep mode.

The UI 600 may also include a second selector 604. The selector 604 may be selectable to automatically without further user input present a settings UI for configuring settings related to the assistant, such as the UI 800 of FIG. 8 which will be described below.

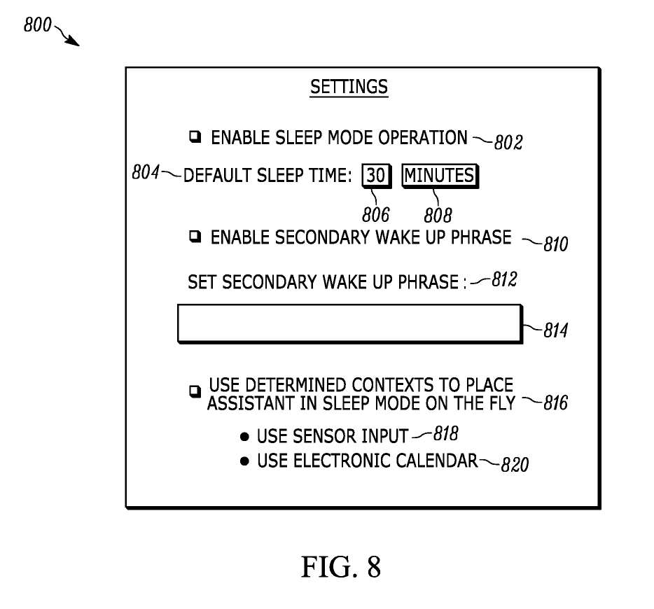

However, FIG. 7 will be described first. FIG. 7 shows another way in which an assistant may be placed into a sleep mode based on input from a user in accordance with present principles. FIG. 7 shows a device 700 that executes/operates the assistant. In some examples, the device 700 may be a stand-alone device operating the assistant. The device 700 may have a capacitive touch-enabled button, depressable button, and/or physically transitionable switch 702. If the element 702 is a touch-enabled button, selection of it may automatically without further user input provide a command for the assistant to be transitioned to a sleep mode as described herein. If the element 702 is a depressable button or physically transitionable switch, it may be respectively depressed or transitioned from one configuration to another configuration to automatically without further user input provide a command for the assistant to be transitioned to the sleep mode.

For example, if the element 702 were a switch, the switch may be transitioned from a sleep mode “off” position to a sleep mode “on” position to provide a command for the assistant to transition to its sleep mode. The switch may then be transitioned from the sleep mode “on” position to the sleep mode “off” position when desired to provide a command for the assistant to transition back to its active mode.

The device 700 may also include another element 704 which may also be a capacitive touch-enabled button and/or depressable button. If the element 704 is a touch-enabled button, selection of it may automatically without further user input provide a command for the assistant to be transitioned to an active mode as described herein. If the element 704 is a depressable button, it may be physically pressed to automatically without further user input provide a command for the assistant to be transitioned to the active mode.

Notwithstanding the foregoing, note that in other embodiments the elements 702 and 704, if they are touch-enabled or depressable buttons, may actually be but a single button so that a first selection of it may transition the assistant to the sleep mode and a second, subsequent selection of it may transition the assistant back to the active mode.

Now in reference to FIG. 8, the UI 800 referenced above is shown. The UI 800 may be presented on a display accessible to a digital/personal assistant in accordance with present principles, and/or a display of a device that controls the assistant in accordance with present principles. For example, the UI 800 may be presented on the display of a smart phone that either executes the assistant at the smart phone itself or communicates with another device (e.g., stand-alone device) executing the assistant.

In any case, the UI 800 may include a first option 802 that is selectable (using the check box shown) to enable transitioning and/or operating of the assistant in a sleep mode as described herein. The UI 800 may also include an option 804 to configure a default sleep time for the sleep mode, expiration of which may cause the assistant to transition back to the active mode. The default sleep time may be configured by providing input to one or more input boxes for defining the sleep time, such as the number entry box 806 and time increment entry box 808.

The default sleep time may be used, for example, when a user instructs the assistant to go to sleep but does not stipulate a period of time for which the assistant is to sleep (e.g., just “assistant, go to sleep” without more). As another example, the default sleep time may also be used when no user is detected as being proximate to the device executing the assistant for a threshold amount of time, as may be determined based on input from a camera, microphone, proximity sensor, etc. As yet another example, the default sleep time may also be used when no audible input directed to the assistant is received for at least a threshold amount of time.

The UI 800 may also include an option 810 that is selectable (using the check box shown) to enable use/recognition of a secondary wake up phrase to transition the assistant from its sleep mode back to its active mode. Thus, when the option 810 selected, a device operating the assistant may be configured to listen for and recognize a secondary wake up phrase while in sleep mode, whereas when the option 810 is not selected the device may continue to operate the assistant in the sleep mode for a predefined period of time regardless of any audible input that might be attempted by a user while in sleep mode.

A secondary wake up phrase in accordance with present principles may even be defined by a user. Thus, option 812 may also be included on the UI 800. The option 812 may include a text entry box 814 at which the user may enter a phrase (e.g., one or more words) to establish as the secondary wake up phrase. Though not shown for simplicity, a similar option for a sleep phrase may also be included on the UI 800 along with a corresponding text entry box for entering a phrase to establish as the sleep phrase.

The UI 800 may also include an option 816 that is selectable (using the check box shown) to use determined contexts to place the assistant in its sleep mode on the fly in accordance with present principles, such as in instances where a user might not actually provide affirmative input for the assistant to be placed in its sleep mode but the device determines nonetheless that it should be placed in its sleep mode. A sub-option 818 may be presented that is selectable (using the radio button shown) to use input from sensors such as a microphone and camera to identify such contexts. A sub-option 820 may also be presented that is selectable (using the radio button shown) to use an electronic calendar to identify such contexts.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory, propagating signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor; and
storage accessible to the at least one processor and bearing instructions executable by the at least one processor to:
operate a digital assistant;
receive input indicating that the digital assistant should be placed in a sleep mode; and
responsive to receipt of the input, place the digital assistant in the sleep mode for a period of time.

2. The device of claim 1, wherein the digital assistant, while in the sleep mode, is still able to receive a secondary wake up phrase different from a primary wake up phrase that is usable while the digital assistant is not in the sleep mode.

3. The device of claim 2, wherein the digital assistant does not process audible input while in the sleep mode except for input of the secondary wake up phrase.

4. The device of claim 3, wherein the instructions are executable by the at least one processor to:
responsive to receipt of first audible input of the secondary wake up phrase, transition the digital assistant from the sleep mode to an active mode.

5. The device of claim 4, wherein the instructions are executable by the at least one processor to:
responsive to the transition from the sleep mode to the active mode, operate the digital assistant to process second audible input not comprising the secondary wake up phrase.

6. The device of claim 5, wherein the instructions are executable by the at least one processor to:
receive the second audible input, wherein the second audible input comprises the primary wake up phrase;
responsive to receipt of the second audible input, process the second audible input to enable the digital assistant to execute a function responsive to receipt of a user request;
receive third audible input comprising a user request; and
responsive to receipt of the third audible input, execute a function using the third audible input.

7. The device of claim 5, wherein the instructions are executable by the at least one processor to:
receive the second audible input, wherein the second audible input comprises input other than the primary and secondary wake up phrases; and
responsive to receipt of the second audible input, process the second audible input to execute a function using the second audible input.

8. The device of claim 1, wherein the period is predefined.

9. The device of claim 1, wherein the period is identified from the input indicating that the digital assistant should be placed in the sleep mode.

10. The device of claim 1, wherein the instructions are executable by the at least one processor to:
responsive to expiration of the period of time and without additional user input, transition the digital assistant from the sleep mode to an active mode in which the digital assistant is enabled to receive a user request and perform a function in conformance with the user request, wherein the digital assistant while in the sleep mode is unable to process any audible input until expiration of the period of time.

11. The device of claim 3, wherein the instructions are executable by the at least one processor to:
responsive to expiration of the period of time and without additional user input, transition the digital assistant from the sleep mode to an active mode in which the digital assistant is enabled to process audible input other than input of the secondary wake up phrase.

12. The device of claim 1, wherein while in the sleep mode the digital assistant does not store data pertaining to audible input received at the device other than data pertaining to a secondary wake up phrase different from a primary wake up phrase usable while the digital assistant is not in the sleep mode.

13. The device of claim 1, wherein while in the sleep mode the digital assistant is not used to access data except for recognition of a secondary wake up phrase different from a primary wake up phrase usable while the digital assistant is not in the sleep mode.

14. The device of claim 5, wherein the at least one processor comprises a central processing unit (CPU) and a digital signal processor (DSP), and wherein the digital assistant is implemented using both the CPU and the DSP.

15. A method, comprising:
operating, at a device, a personal assistant in a first mode;
receiving, at the device, input to place the personal assistant in a second mode different from the first mode, wherein in the second mode the personal assistant does not process speech other than of a phrase to transition the personal assistant back to the first mode;
operating, responsive to receiving the input, the personal assistant in the second mode for a period of time; and
operating, responsive to a determination pertaining to the period of time, the personal assistant in the first mode.

16. The method of claim 15, wherein the period of time is a quantifiable amount of time, and wherein the determination pertaining to the period of time comprises a determination that the quantifiable amount of time has lapsed.

17. The method of claim 15, wherein the period of time is not a quantifiable amount of time, and wherein the determination pertaining to the period of time comprises a determination regarding whether an event has concluded, the event associated with the not quantified amount of time.

18. The method of claim 15, comprising:
operating the personal assistant in the first mode using a general purpose processor; and
operating the personal assistant in the second mode using a digital signal processor (DSP) and a field programmable gate array (FPGA).

19. The method of claim 15, comprising:
operating the personal assistant in the first mode and the second mode using a general purpose processor.

20. An apparatus, comprising:
a first processor;
a network adapter; and
storage bearing instructions executable by at least one second processor of a device for:
operating, at the device, a personal assistant in a first mode;
receiving, at the device, first input indicative of a circumstance for which to operate the personal assistant in a second mode different from the first mode, wherein in the second mode the personal assistant does not respond to a primary wake up phrase for the personal assistant, and wherein in the second mode the personal assistant does not respond to user requests for information;
operating, at the device and responsive to receiving the first input, the personal assistant in the second mode for a period of time;
receiving, at the device, second input indicative of a circumstance for which to operate the personal assistant in the first mode; and
operating, at the device and responsive to receiving the second input, the personal assistant in the first mode;
wherein the first processor transfers the instructions to the device over a network via the network adapter.
